(19) United States
(12) Patent Application Publication
(10) Pub. No.: US 2012/0173535 A1
(43) Pub. Date: Jul. 5, 2012

(54) Allowing External Access to Private Information of a Local Data Store

(75) Inventors: Arun Ramakrishnan, Chennai (IN); Rohit Shetty, Bangalore (IN)

(73) Assignee: INTERNATIONAL BUSINESS MACHINES CORPORATION, Armonk, NY (US)

(21) Appl. No.: 12/984,771

(22) Filed: Jan. 5, 2011

(51) Int. Cl. G06F 21/00; G06F 17/30

(52) U.S. Cl. 707/741; 726/28; 707/785; 707/E17.002; 707/E17.044; 707/E17.01

(57) ABSTRACT

Techniques provided for allowing external access by other users to private information that is maintained on local storage of a computer and owned by an information owner. The private information is uploaded from the local storage to an externally accessible information source that is accessible by the other users. A request from a user to access the private information is received by the owner, who determines whether to allow access the private information. If so, the owner sends a private information sharing authorization to a collaboration orchestrator, which retrieves the private information from the external source and provides the private information to the user. The owner optionally requests to collaborate with the user before deciding whether to allow access to the private information. One or both of the identities of the owner and user can remain anonymous until agreeing on revealing identities. A system and program product is also provided.

### BACKGROUND

1. Field

The disclosure relates generally to a data sharing technique, and more specifically to a technique for sharing private data maintained by a user at a data processing system.

2. Description of the Related Art

By some estimates, approximately 60% of an organization's information wealth lies on individual user desktops. As individuals work and grow in an organization, they create a lot of information in their respective fields of expertise. This information, in some form of document, is distributed across various sources in an organization. Through various tools some of it may be publicly available, some may be shared, but most of it remains private to the owner/creator of the documents. Private information cannot be used by anyone else without explicit awareness about the location, its content and access. This information is essentially lost to the rest of the organization.

For example, taking a scenario that might well occur, an engineer on a customer solutions team needs to install a complex product such as a distributed database solution, and runs into problems during configuration. It is difficult for the engineer to locate information on some of the more complex and obscure issues that may arise. The engineer can only get to 40% of the total information that is available. The remaining 60% represents a massive amount of unreachable knowledge and information. Collaborative initiatives become hampered or held up while trying to locate people and information about work done in the same field, or products that may be involved, etc. Currently, no systems or solutions exists which allow an organization to make use of these independent and very valuable sources of information.

The techniques and ideas presented herein present a methodology by which information previously inaccessible can be leveraged across an organization in a controlled and uncoupled manner, thus enabling an organization to exploit the full potential of its information wealth.

### SUMMARY

According to one embodiment of the present invention, a method is performed by a data processing system for allowing external access by other users to private information that is maintained on a local data store of the data processing system and owned by an information owner. The private information is uploaded from the local data store to an externally accessible information source that is accessible by the other users. A request is received to access the private information. In response to receiving the request, a determination is made as to whether to allow access to the private information. In response to determining that access to the private information is allowed, a private information sharing authorization is sent to allow to access the private information.

### BRIEF DESCRIPTION OF THE SEVERAL VIEWS OF THE DRAWINGS

FIG. 1 depicts a pictorial representation of a network of data processing systems in which illustrative embodiments may be implemented;

FIG. 2 depicts a data processing system in accordance with an advantageous embodiment;

FIG. 3 depicts an overall system for providing document access capabilities using indexing and search capabilities;

FIG. 4 depicts the overall logical flow of the system for providing document access capabilities using indexing and search capabilities;

FIG. 5 depicts a representative graphical user interface (GUI) that is used to present search results to a user/searcher;

FIG. 6 depicts a representative GUI that is used to allow a user/searcher to initiate collaboration with another user(s); and

FIG. 7 is a flow chart of the operating actions provided by the system for providing document access capabilities using indexing and search capabilities.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

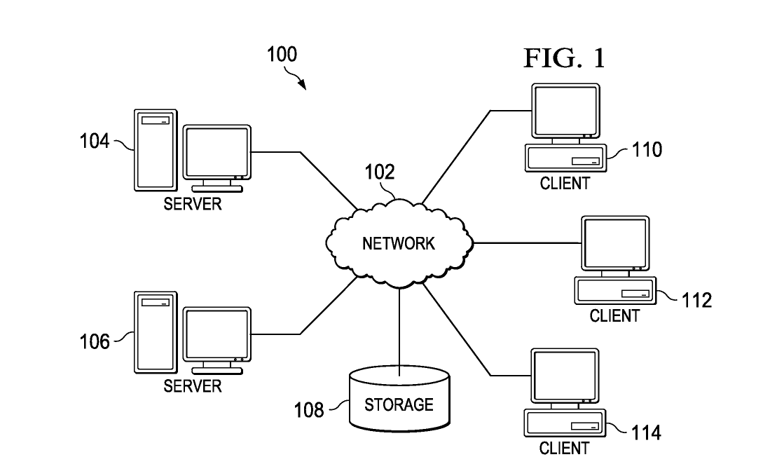

With reference now to the figures and, in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

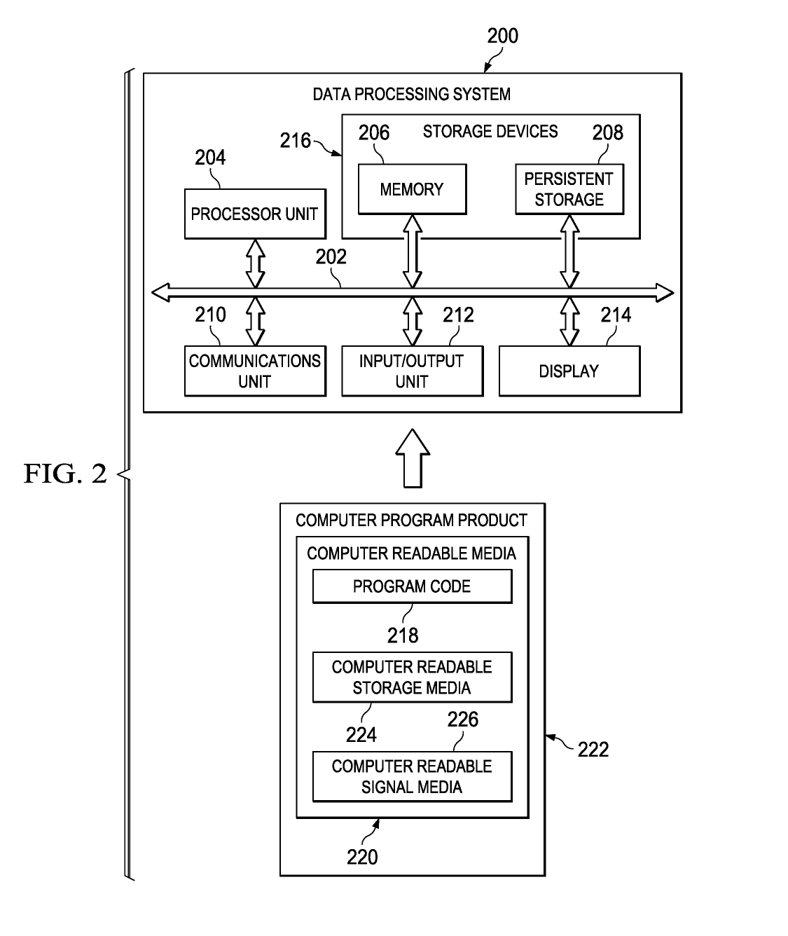

Turning now to FIG. 2, an illustration of a data processing system is depicted in accordance with an advantageous embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some advantageous embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different advantageous embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 204 may take the form of a hardware unit that has circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 218 may be omitted because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache, such as found in an interface and memory controller hub that may be present in communications fabric 202.

The techniques discussed herein present a solution to the above mentioned problem of external access by others to private information, such as documents, that are locally maintained on a user's computer. It covers a method, system and computer program product by which private information, along with public/shared information, from various sources can be leveraged by the entire organization in a controlled manner that protects each user's privacy.

The proposed system and related methodology provide a way for organizations to share private data securely without invading a user's privacy. Data previously inaccessible is now available to everyone in an organization through a controlled and auditable manner. Through this system, an organization is able to make complete use of its information wealth. This system is lightweight and inexpensive. Users can locate relevant information quickly. In addition, collaborative efforts can be initiated by locating users with relevant information. The system/methodology allows for search driven collaboration in any form, such as work initiatives, setting up meetings, etc. The system/methodology significantly improves the capability of organizations to exploit their vast source of untapped information and allows people to act and take well informed decisions quickly.

Documents are available from various sources. For example, document owners may choose to upload documents to file sharing applications. From here, others may search and retrieve these documents if they have been marked as ‘Public’; or if the owners explicitly ‘Share’ these documents with specific individuals or groups, then they may access these. The ‘Private’ documents however, are not and should not be revealed openly in any form to others except as provided by the features described herein.

According to a preferred embodiment, in the document source (e.g., file sharing applications, desktops etc.), a document owner marks a document as Public, Shared (with individuals or groups) or Private. When these documents are made available, they are indexed by their content and appropriate metadata. The system of indexing may choose to store user and document access information, i.e., the owner of the document and all other users who have access to this document. While performing this indexing, the document owner's details are vital in order to track the document's visibility. An external lightweight directory access protocol (LDAP) or user directory provides this information during indexing. The index entry for each document is supplemented with user details and the document's source. Now that the documents have been indexed and the entries have been enriched with appropriate metadata and owner information, searches can be performed. The indexes may contain user information about the document owner. In this situation, the indexes will contain the owner information and also information to cover the visibility of the document, i.e., the other users that have access or it will indicate that access is public. If this information is not maintained in the indexes themselves, then the search module needs to query the user directory and the document sources whenever this information is required.

At this point another user, a document searcher, becomes involved. The document searcher performs a search for required information. For example, this could be “Database Install Troubleshooting” or perhaps “India Automobile Market Study 2010”. The indexes are queried and the top matching documents are selected. For a searcher, results are made available in categories. In order to categorize these documents, further information is required. The system needs to know the owner of the documents and the users that have access to the documents. If this information is not available in the index, then the search system will query from the user directory and the document source for this information. One category contains all public documents or documents that an owner has explicitly shared with the searcher. Since the searcher has been allowed access to these documents, the searcher is presented with details of the document. They would typically include a summary, the owner, the document type, the last updated date, etc. The searcher can then choose to retrieve this document.

Another category contains all private documents, i.e., documents that owners have not explicitly shared or the searcher does not have access to. It is important at this point that the searcher is not given any private details of the documents, e.g., content, owner details, etc. The searcher can, however, be shown harmless information on the results of the search, e.g., the number of documents that matched the search, the relevance, recentness, etc. The searcher can then choose to send a request for these documents or collaborate. On behalf of the searcher, the system sends a request to the document owner for the document(s) or collaboration. This request may or may not reveal the identity of the searcher. This request may or may not reveal the nature or reason for the request. Additionally, the owner could be presented with the search query that matched the documents. At this point, the document owner can respond to this request in a number of ways. The owner can approve the request and this in turn shares the document(s) with the searcher. The owner could reject or ignore the request, which ends the collaboration at this point. Such rejection may or may not include the reasons why such request was rejected. The owner could also initiate/approve collaboration with the searcher before deciding whether to approve the request, while optionally not revealing the owner's identity until after deciding to approve the request.

In addition, the owner can choose to stop the document(s) from matching the given query. The owner would typically do this when a document matches an overly generic query. For example, the search key “India” would match too many documents and provide no value to the search. The owner can choose to remove this key from the index entry for that particular document. Conversely, the document owner may choose to be matched only for specific keywords. For example, a security expert might choose to only have matches for terms such as security, encryption, or privacy, etc.

The owner may choose to remove the document from the index altogether. For example, personal documents that have become indexed erroneously like pay slips or tax related documents cannot be shared.

While requesting a document, the searcher can choose to remain anonymous. The document owner then receives a request where the searcher's identity is not disclosed. The owner can also choose to interact with the searcher in various ways. The owner can choose to request for the searcher's identity by revealing the owner's identity as well. This situation creates a platform from with any type of collaboration can be made possible. The searcher or owner can setup meetings, or the owner could share more related documents. The document searcher is now empowered with a much larger source of information.

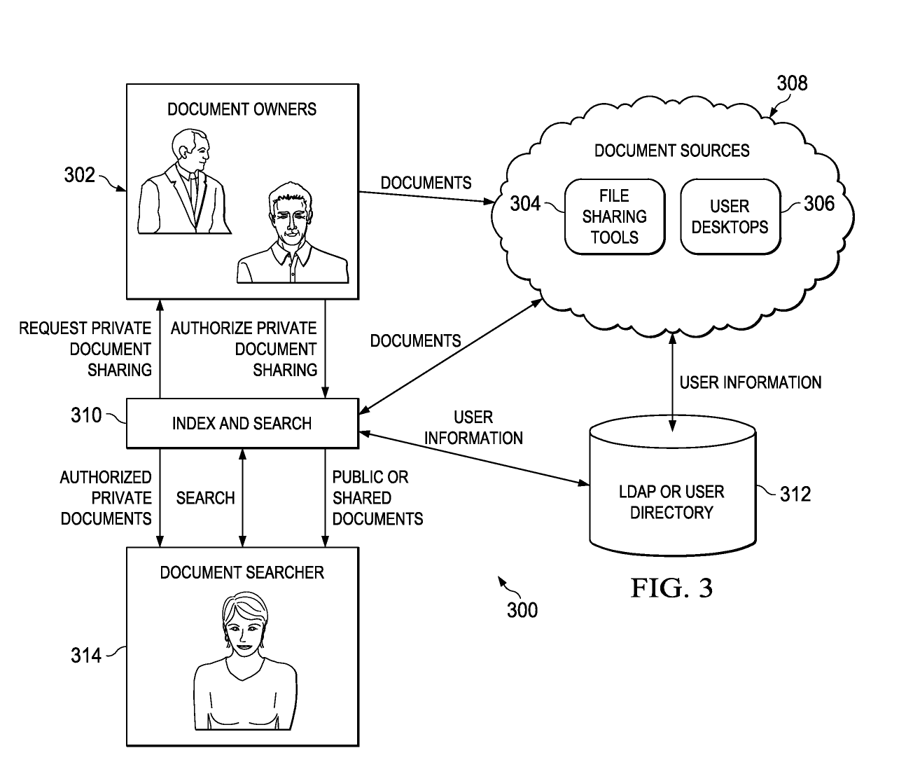

Turning now to FIG. 3, there is shown at 300 the overall system for providing document access capabilities using indexing and search capabilities. Documents are available from various sources. For example, document owners 302 may choose to upload documents to a file sharing application/tools 304 or user desktop(s) 306—collectively depicted as document sources 308 (aka externally accessible information source). From here, others may search and retrieve these documents if they have been marked as ‘Public’. If the document owners 302 explicitly ‘Share’ these documents with specific individuals or groups, then the specific individuals or groups may access these documents.

According to a preferred embodiment, in the document source (e.g., file sharing applications, desktops, etc.), a document owner marks a document as Public, Shared (with individuals or groups) or Private. When these documents are made available to document sources 308 by the document owners, they are indexed by index and search module 310 according to their content and appropriate metadata. The system of indexing can choose to store user and document access information, i.e., the owner of the document and all other users who have access to this document. While performing this indexing, the document owner's details are vital in order to track the document's visibility. An external LDAP or user directory 312 provides this information during indexing. The index entry for each document is supplemented with user details and the document's source. Now that the documents have been indexed and the entries have been enriched with appropriate metadata and owner information, searches can be performed. The indexes may contain user information about the document owner. In this situation, the indexes will contain the owner information and also information to cover the visibility of the document, i.e., the other users that have access or it will indicate that access is public. If this information is not maintained in the indexes themselves then the search module needs to query the user directory and the document sources whenever this information is required.

At this point another user, a document searcher 314, becomes involved. The document searcher 314 performs a search for required information. The indexes are queried and the top matching documents are selected. Public and shared documents are conditionally provided by the index and search module 310 based upon the particular access controls established for such public shared document. For private documents that are identified in the top matching documents, a request for private document sharing is sent from the index and search module 310 to the particular document owner 302, who dynamically decides whether or not to authorize such private document to be made available. This request may or may not reveal the identity of the searcher. The index and search module 310 then accesses any authorized private documents from document sources 308 and provides the same to the document searcher 314.

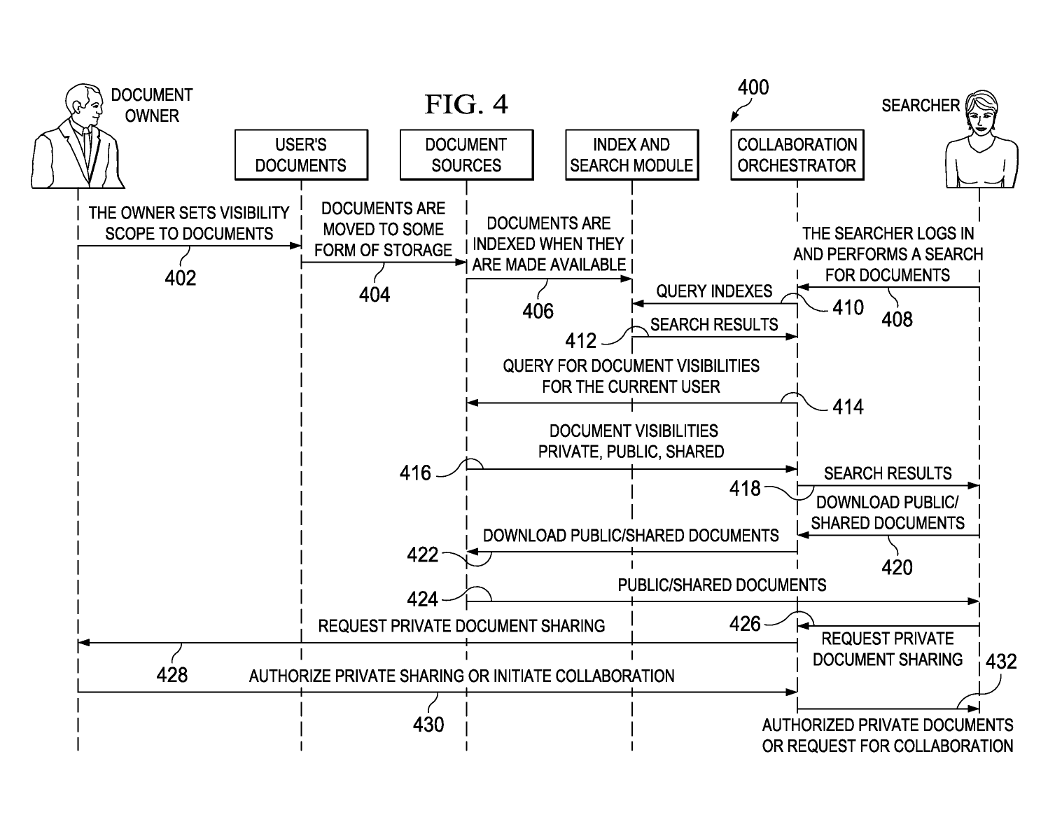

Turning now to FIG. 4, there is shown at 400 the logical flow of the system for providing document access capabilities using indexing and searching capabilities. At step 402, the document owner sets the visibility scope to one or more of the user's documents. At step 404, the documents are moved to some form of storage that is commonly accessible by others to form the document sources 308 of FIG. 3. At step 406 the documents are indexed when they are made available by the document owner. Such indexing is performed by index and search module 310 of FIG. 3. At this point, the documents are now available for searching by a searcher.

A searcher, such as document searcher 314 of FIG. 3, can then login and perform a search for documents at 408, where a search is either formulated in conjunction with, or sent to, a collaboration orchestrator. The collaboration orchestrator queries the indexes maintained by the index and search module (element 310 of FIG. 3) at step 410, which returns results to the collaboration orchestrator at step 412. The collaboration orchestrator then queries for document visibilities for the current user, i.e., the searcher, at 414. The document sources (element 308 of FIG. 3) then return the results of such query at step 416, including identification of any document(s) matching the search for which the searcher has been given appropriate access via the Public, Shared and Private settings previously established by the document owner, to the collaboration orchestrator, who forwards such search results to the searcher at step 418.

The searcher then issues a command to the collaboration orchestrator to download public/shared documents of interest at step 420, who forwards such command (either in its current form, or in a modified form to match the interface(s) of the document sources) to the document sources at step 422. The requested documents are then sent to the searcher at step 424.

The private document aspects associated with the document owner are now processed. At step 426 the searcher sends a request for private document sharing to the collaboration orchestrator, who forwards such request/command (either in its current form or in a modified form to match the interface of the document owner), to the document owner at step 428. This request/command may or may not reveal the identity of the searcher. The document owner then sends to the collaboration orchestrator either an authorization for private sharing of the private document(s) or initiates collaboration at step 430, which is forwarded (either in its current form, or in a modified form to match the interface(s) of the searcher) to the searcher at step 432.

If user and document visibility information is maintained in the index, the system does not need to query document sources for this information, such as is provided in steps 414 and 416, after a search has been performed. Instead, the search results retrieved from the indexes will contain all the relevant data required to be presented to the searcher. Accordingly, steps 414 and 416 would not be performed in this index-visibility scenario. This approach involves more processing during indexing but decreases searching times and makes the system faster for the searcher.

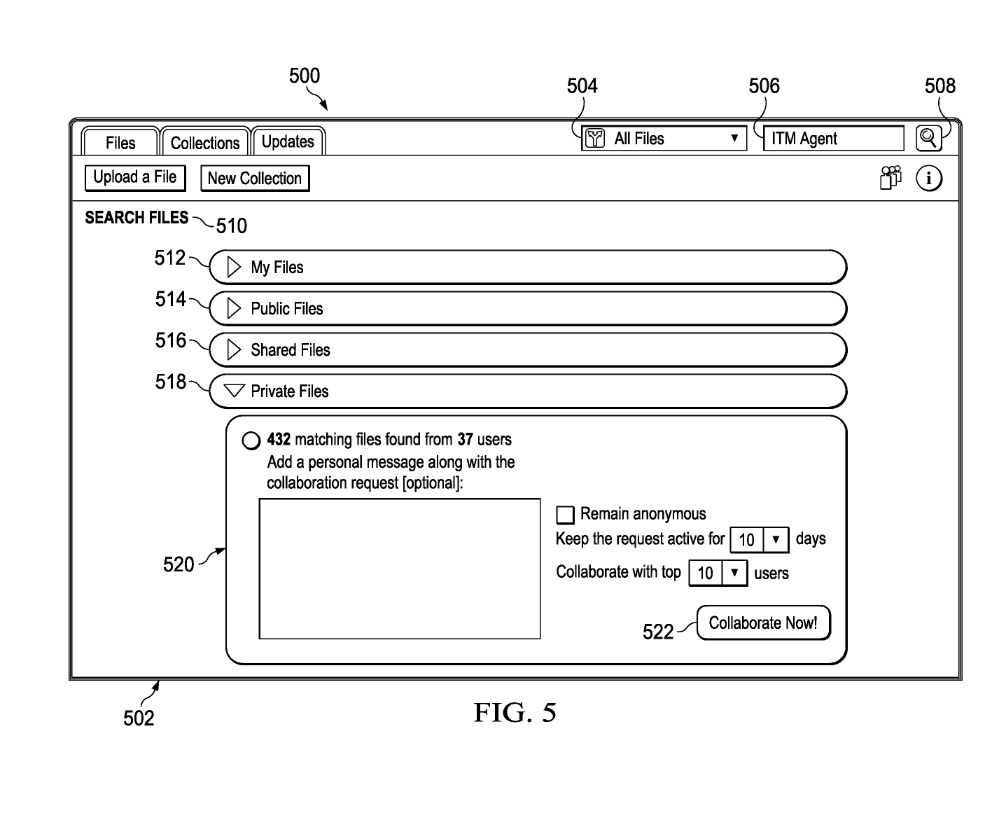

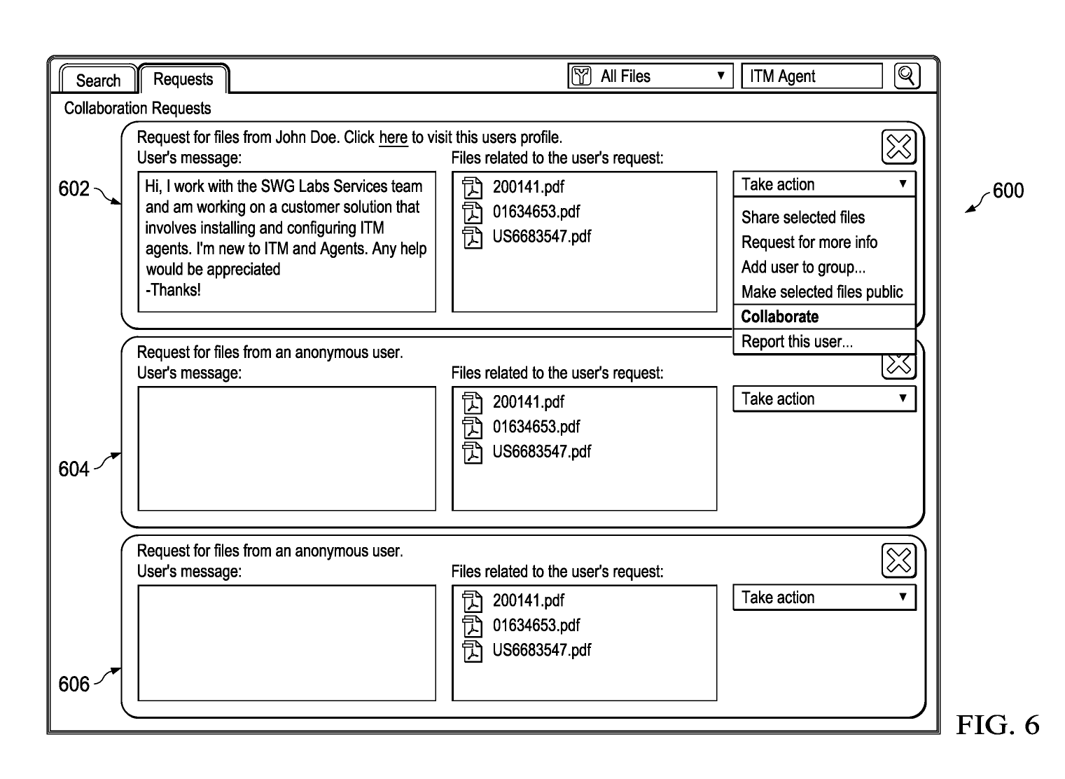

An interface to the system could be implemented in any form. A representative example of a graphical user interface (GUI) that is presented to a user is shown in FIGS. 5 and 6.

Shown at 500 of FIG. 5 depicts a representative graphical user interface (GUI) that is used to present search results to a user/searcher. A window 502 is provided where search terms can be input, and resulting search results can be presented to a searcher/user. For example, a searcher has requested that all files be searched at 504 for the search term “ITM Agent” at 506. Pressing the search key 508 initiates the search, as per step 408 of FIG. 4. The resulting search files are shown at 510, and include “My Files” 512 which pertain to locally maintained files within the searchers computer, “Public Files” 514 which pertain to ‘Public’ files in document sources 308 of FIG. 3, “Shared Files” 516 which pertain to the ‘Shared’ files in document sources 308 of FIG. 3, and “Private Files” 518 which pertain to the ‘Private’ files in document sources 308 of FIG. 3. The “Private Files” 518 tab has been selected to expand the listing for these private files at 520, where 432 matches were found from 37 users who have uploaded and indexed their private files into document sources 308 of FIG. 3, as previously described.

Also shown in FIG. 5 is a “Collaborate Now” button 522, which when selected allows a user to initiate collaboration with one or more other individuals. Selecting such button initiates a request for collaboration to be sent one or more document owners. A given document owner is presented with a “Collaborations Request” screen, such as shown at 600 of FIG. 6. Here, three collaboration requests are outstanding—John Doe has requested collaboration at 602, an anonymous user has requested collaboration at 604, and another anonymous user has requested collaboration at 606. This screen could be used to authorize collaboration such as is provided by step 430 of FIG. 4, for example.

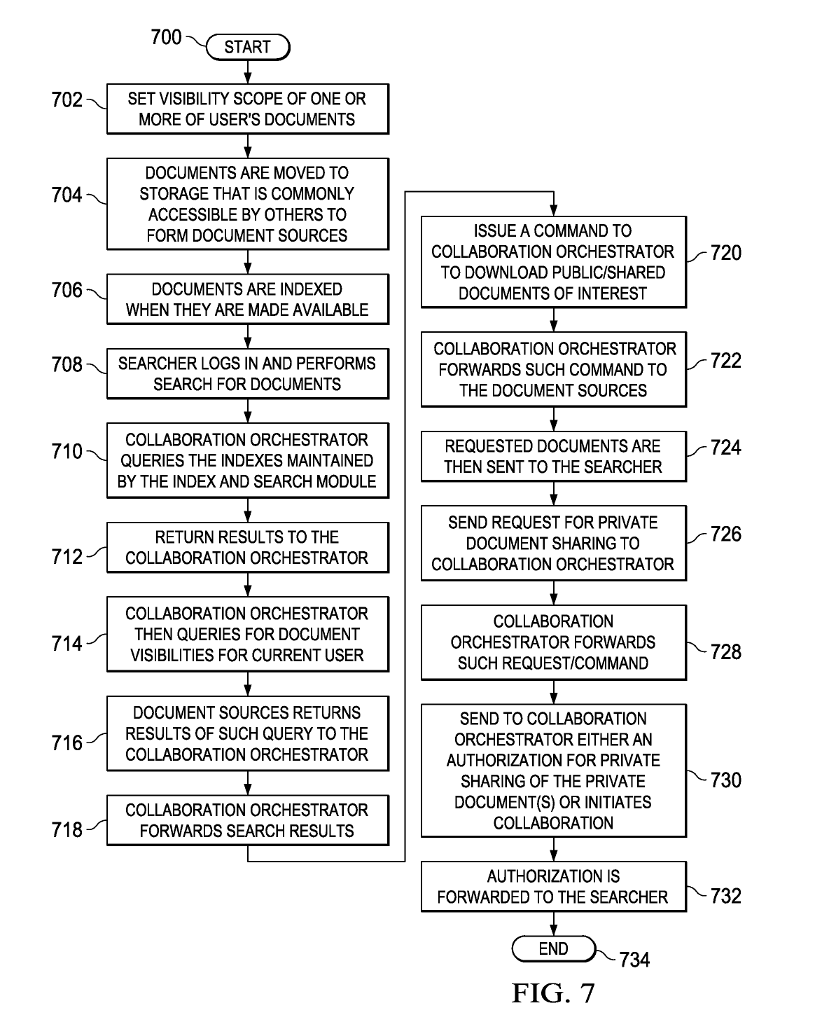

Turning now to FIG. 7, a flowchart of the operating actions provided by the system for providing document access capabilities using indexing and search capabilities. Processing begins at 700, and proceeds to step 702 where the visibility scope of one or more of its documents is set by a local machine in response to actions by the document owner. At step 704, the documents are moved to some form of storage that is commonly accessible by others to form the document sources 308 of FIG. 3. At step 706 the documents are indexed when they are made available. Such indexing is performed by index and search module 310 of FIG. 3. At this point, the documents are now available for searching by a searcher.

A searcher, such as searcher 314 of FIG. 3, can then login and perform a search for documents at step 708, where a search is either formulated in conjunction with, or sent to, a collaboration orchestrator. The collaboration orchestrator queries the indexes maintained by the index and search module (element 310 of FIG. 3) at step 710, which returns results to the collaboration orchestrator at step 712. The collaboration orchestrator then queries for document visibilities for the current user—i.e., the searcher, at step 714. The document sources (element 308 of FIG. 3) then returns the results of such query at step 716, including the document(s) matching the search for which the searcher has been given appropriate access via the Public, Shared and Private settings previously established by the document owner, to the collaboration orchestrator, who forwards such search results from the local machine to a searcher machine of the searcher at step 718.

The searcher, using the searcher machine, then issues a command to the collaboration orchestrator to download public/shared documents of interest at step 720, who forwards such command (either in its current form, or in a modified form to match the interface(s) of the document sources) to the document sources at step 722. The requested documents are then sent to the searcher at step 724.

The private document aspects associated with the document owner are now described. At step 726 the searcher sends a request for private document sharing to the collaboration orchestrator, who forwards such request/command (either in its current form, or in a modified form to match the interface(s) of the document owner) to the document owner's local machine at step 728. This request/command may or may not reveal the identity of the searcher. The document owner then uses the local machine to send to the collaboration orchestrator either an authorization for private sharing of the private document(s) or initiates collaboration at step 730, which is forwarded (either in its current form, or in a modified form to match the interface(s) of the searcher) to the searcher at step 732. The owner can optionally not reveal their identity at all, or wait to reveal their identify until after deciding to approve the request as a result of the collaboration. The process then ends at 734.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-16. (canceled)

17. An apparatus for allowing external access by other users to private information that is owned by an information owner, comprising a data processor coupled to a memory and operable for executing instructions in the memory to perform the steps of:
allowing an external search of the private information by the other users;
the data processing system receiving a request by a user of the other users to access the private information;
responsive to receiving the request, the data processing system determining whether to allow the user to access the private information; and
responsive to determining that the user is allowed to access the private information, the data processing system sending a private information sharing authorization to allow the user to access the private information.

18. A computer program product comprising a computer-readable recordable storage medium, the computer-readable recordable storage medium having stored thereon program code that is operable for, when executed by a data processing system, performing the steps of:
allowing an external search of the private information by the other users;
the data processing system receiving a request by a user of the other users to access the private information;
responsive to receiving the request, the data processing system determining whether to allow the user to access the private information; and
responsive to determining that the user is allowed to access the private information, the data processing system sending a private information sharing authorization to allow the user to access the private information.

19. The computer program product as described in claim 18, wherein the program code is stored in the computer-readable recordable storage medium in a data processing system, and wherein the program code was downloaded over a network from a remote data processing system.

20. The computer program product as described in claim 18, wherein the program code is stored in the computer-readable recordable storage medium in a server data processing system, and wherein the program code is downloaded over a network to a remote data processing system for use in another computer-readable recordable storage medium with the remote data processing system.

21. The apparatus according to claim 17, wherein the sending step comprises the sending the private information sharing authorization to a collaboration orchestrator.

22. The apparatus according to claim 21, wherein the user sends the request to the collaboration orchestrator, who forwards such request to the information owner.

23. The apparatus according to claim 21, wherein the collaboration orchestrator retrieves the private information from an externally accessible information source where the private information is maintained, and provides the private information to the user.

24. The apparatus according to claim 17, further comprising retrieving the private information from an externally accessible information source where the private information is maintained.

25. The apparatus according to claim 24, wherein the externally accessible information source comprises information categorized as public, shared and private.

26. The apparatus according to claim 24, wherein the externally accessible information source is a file sharing application running on the data processing system.

27. The apparatus according to claim 17 further comprising indexing the private information at an externally accessible information source where the private information is maintained to form a plurality of index records.

28. The apparatus according to claim 27, wherein an index record comprises user information about the information owner.

29. The apparatus according to claim 28, wherein the user information is retrieved from a user directory.

30. The apparatus according to claim 29, wherein the user directory is an external lightweight directory access protocol (LDAP) directory.

31. The apparatus according to claim 17 further comprising the receiving a collaboration request to collaborate with respect to the private information.

32. The apparatus according to claim 31, wherein the collaboration request does not reveal an identify of the user.

33. The apparatus according to claim 17 further comprising the information owner sending a collaboration request to the user to collaborate with respect to the private information.

34. The apparatus according to claim 33, wherein the collaboration request does not reveal an identify of the information owner and the request does not reveal an identify of the user.

35. The apparatus according to claim 33, wherein the collaboration request is sent before the private information sharing authorization is sent.
